(19) United States
(12) Patent Application Publication
(10) Pub. No.: US 2022/0080505 A1
(43) Pub. Date: Mar. 17, 2022

(54) PROCESSING POWDER SUITABLE FOR LASER MELTING WITH A CENTRAL INERT GAS DISTRIBUTOR AND WITH OXYGEN MONITORING

(71) Applicant: TRUMPF Laser- und Systemtechnik GmbH, Ditzingen (DE)

(72) Inventors: Wolfgang Laib, Besigheim (DE); Daniel Giek, Stuttgart (DE)

(21) Appl. No.: 17/536,750

(22) Filed: Nov. 29, 2021

Related U.S. Application Data
(63) Continuation of application No. PCT/EP2020/063917, filed on May 19, 2020.

(30) Foreign Application Priority Data
Jun. 14, 2019 (DE) 102019208689.6

(51) Int. Cl. B22F 10/322; B22F 10/28; B22F 12/41; B22F 12/70; B22F 12/90; B22F 1/14; B33Y 10/00; B33Y 30/00; B33Y 40/10

(52) U.S. Cl. CPC B22F 10/322; B22F 10/28; B22F 12/41; B22F 12/70; B22F 2201/10; B22F 1/14; B33Y 10/00; B33Y 30/00; B33Y 40/10; B22F 12/90

(57) ABSTRACT

The disclosure provides systems and methods for processing powder suitable for laser melting, with at least one component that is or comes into contact with the powder and to which an inert gas is fed. The systems include a central inert gas distributor, which can be connected or is connected to an inert gas source and to which the at least one component is connected by way of an activatable valve, an oxygen sensor in the at least one component, and a controller, which activates the valve on the basis of measurement data of the oxygen sensor. As an alternative or in addition to the central inert gas distributor, the system can have a data processing unit, which records and evaluates the measurement data of the oxygen sensor.

### CROSS REFERENCE TO RELATED APPLICATIONS

This application is a continuation of and claims priority under 35 U.S.C. § 120 from PCT Application No. PCT/EP2020/063917, filed on May 19, 2020, which claims priority from German Application No. 10 2019 208 689.6, filed on Jun. 14, 2019. The entire contents of each of these priority applications are incorporated herein by reference.

### TECHNICAL FIELD

The present disclosure relates to systems and methods for processing powder suitable for laser melting, with at least one component that is or comes into contact with the powder and to which an inert gas is fed.

### BACKGROUND

Methods for laser melting (laser metal fusion) are known from the prior art. They involve building up a workpiece layer by layer by melting a powder by means of a laser beam. Among other things, to avoid contamination of the powder with oxygen, the melting process takes place under an inert gas atmosphere. Before the melting process, the powder is cleaned by a sieving station. After the melting process, the powder that has not melted may be cleaned and reused for a new building process. Before the melting process, the powder may be stored, for example, in powder silos.

DE 10 2009 005 769 A1 describes a system for reusing residual powder from an installation for the generative manufacturing of three-dimensional objects. The system comprises a building apparatus for applying the powder material and for shaping an object by irradiation. The system also comprises a sucking apparatus, separate from the building apparatus, for transporting the residual powder and a sieving station for sieving the residual powder.

### SUMMARY

The present disclosure provides systems and methods for handling of powder under controlled environmental conditions and with monitoring of the environmental conditions.

In one aspect, the present disclosure provides systems that include a central inert gas distributor, which can be connected to, or is connected to, an inert gas (e.g., argon, nitrogen) source and to which at least one component is connected by way of an activatable valve, an oxygen sensor in the at least one component, and a controller, which activates the valve on the basis of measurement data of the oxygen sensor. As used herein, a component is any device or system that contains, handles, or processes, the powder and needs to be filled with an inert (protective) gas. Examples of components include, e.g., unpacking stations, sieving stations, and build chambers of 3D printers.

At least one, some, or all of the components that contain, or are “under,” inert gas in a process chain for processing the powder are connected by way of an activatable valve to the central inert gas distributor, wherein the controller activates the valves on the basis of measurement data of the oxygen sensors. The components are “under inert gas,” i.e., filled with inert gas when handling powder, so that the powder will not react, e.g., with water or oxygen from ambient air.

Powder is stored in a powder silo and in a sieving station under an inert gas atmosphere, wherein the amount of inert gas in the at least one component (sieving station, powder silo, glovebox, component chamber, etc.) is controlled centrally by the inert gas distributor and the controller. If the measured oxygen concentration in the component exceeds a prescribed limit value, the associated valve is opened to feed inert gas into the component. Providing the inert gas distributor and the central controller in these systems reduces the need for inert gas feeding devices for each powder silo or other component that are operated separately. The advantages of this central inert gas feedback control are the savings potential brought about by the reduction of the number of components, the uniform data structure, and the easier operation. Environmental influences are reduced to a minimum by the controlled inert gas atmosphere, as a result of which the certainty of the process is thereby increased distinctly and measurably.

The systems and methods described herein make it possible for the inert gas distribution to be easily extended to further components of the apparatus by connection to the central inert gas distributor. The central controller and its uniform data structure allow the systems to be adapted to different specified tasks with comparatively little expenditure of time. For this purpose, the controller has interfaces, which are required for the central function (inert gas feedback control). Examples of the additional interfaces are: inputs for sensor systems (oxygen, humidity, etc.), and outputs to activate the valves (actuators), or mechanical connections, for example, to make process/inert gases (argon, nitrogen) available to the other components as required. The central inert gas distributor with sufficient ports makes the switching/supplying of, for example, multiple powder silos possible here.

Any (desired) “gastight” component of the process chain can be connected (as a module) to the apparatus. The component needs only to be designed with a standardized interface (supplying inert gas feed and discharge, attachment of oxygen sensor, etc.). In some embodiments, an inert gas processing system is connected to the inert gas distributor to centrally prepare the inert gas returned from the components.

In certain embodiments, the central inert gas distributor, the controller, and/or the central inert gas processing system are arranged at a central sieving station (e.g., as the central component of the powder processing). There is only one each of the elements (e.g., inert gas processing system, controller, and visual display (at the sieving station)).

The controller of the sieving station may, for example, undertake the feedback control for all the components. HMI (human machine interface) components allow the operator to switch components on and off or define component-specific properties or control limits, such as, for example, the inert gas flooding time for first-time filling, the control range for the oxygen concentration, etc.

In some embodiments, the inert gas includes argon and/or nitrogen. These inert gases effectively prevent oxidation of the powder in the laser melt.

In a further aspect, the disclosure also relates to systems and methods for processing powder suitable for laser melting, including at least one component that is or comes into contact with the powder and to which an inert gas is fed, an oxygen sensor in the component, and a central data processing unit, which records and evaluates the measurement data of the oxygen sensor.

For example, at least some or all of the components under inert gas of a process chain processing the powder have oxygen sensors, wherein the central data processing unit records and evaluates the measurement data of the multiple oxygen sensors.

The data management/evaluation of the measured oxygen values makes a component-specific powder or oxygen-concentration history possible (e.g., oxygen monitoring). The state of the powder can be recorded in as detailed and comprehensive a manner as possible over its lifetime. Together with the data from the melting process, a comprehensive quality statement can consequently be made with respect to the resultant component. The evaluation of the state data (oxygen and optionally other parameters such as air/gas moisture, temperature, etc.) and their visual display provides the operator with the possibility, from then on, of preparing quality assurance reports. The integration of more and more components and process steps under defined controlled conditions consequently allow the uncertainty of the process to be steadily reduced.

The at least one component can be, for example, a powder silo for storing powder, a sieving station for cleaning the powder conveyed to it from a powder silo, a process chamber of an installation for the additive manufacturing of components or an unpacking station for unpacking and cleaning a freshly produced component.

The powder can include nickel, titanium and/or aluminum. For example, the powder can include alloys of nickel, titanium, and/or aluminum.

Further advantages and advantageous refinements of the subject matter of the invention can be taken from the description, the drawing and the claims. Similarly, the features mentioned herein can each be used on their own or together in any desired combinations. The embodiments shown and described should not be understood as an exhaustive list, but rather are of an exemplary character for the description of the invention.

### DESCRIPTION OF DRAWINGS

FIG. 1 is a schematic that shows a system as described herein for processing powder suitable for laser melting, with a central inert gas distributor and a central data processing unit.

FIG. 2 is a schematic that shows the components under inert gas of a process chain processing the powder.

### DETAILED DESCRIPTION

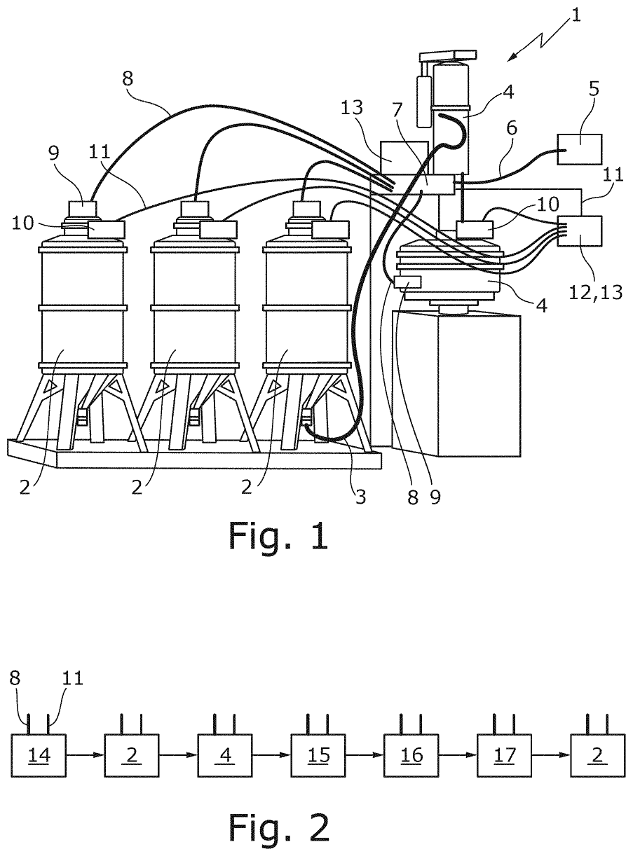

The system 1 shown in FIG. 1 serves for processing powder suitable for laser melting and has one or more powder silos 2 (just by way of example, three here), in which the same or different powder materials are stored. A powder hose 3 is connected to one of the powder silos 2 and to a sieving station 4, to convey powder from the one powder silo 2 into the sieving station 4 for cleaning the powder. The cleaned powder is then further conveyed or transported by means of containers to an installation, e.g., a 3-D printer, not shown here, for the additive manufacturing of components, in which a component is built up layer by layer by melting powder by means of a laser beam.

Connected to an inert gas source 5 by way of a gas transfer conduit 6, e.g., a plastic, rubber, or metal hose, is a central inert gas distributor 7, to which, in turn, all the powder silos 2 and the sieving station 4 are each connected by way of a hose 8 and a—for example, electrically-activatable valve 9, to introduce inert gas. In the powder silos 2 and in the sieving station 4 there are oxygen sensors 10, which measure the oxygen concentration (or an oxygen percentage of the overall gas composition) respectively prevailing in them. In addition, the temperature, humidity, and/or pressure may also be measured.

The valves 9 and the oxygen sensors 10 are connected by way of control lines 11, which, in the exemplary embodiment shown, pass via the central inert gas distributor 7, to a central controller 12, which electrically activates the valves 9 on the basis of measurement data of the oxygen sensors 10, to maintain a prescribed oxygen concentration in the powder silos 2 and in the sieving station 4 by opening and closing the valves 9. Instead of on the powder silos 2 and at the sieving station 4, as in FIG. 1, the valves 9 may also be arranged directly on the inert gas distributor 7. Also, the control lines 11 may be connected directly to the controller 12.

An inert gas processing system 13 for cleaning the inert gas may also be additionally connected to the inert gas distributor 7. In the exemplary embodiment shown, the inert gas distributor 7, the controller 12 and the inert gas processing system 13 are arranged at the sieving station 4.

The oxygen sensors 10 are also connected to a central data processing unit 18, which may be formed separately or, as shown in FIG. 1, as part of the controller 12. The data processing unit 18 records the measurement data of the oxygen sensors 10 and evaluates them to obtain a component-specific powder or oxygen-concentration history (oxygen monitoring) and possibly visually display it to the operator. The state of the powder can thus be recorded in a detailed and comprehensive manner over its lifetime. In addition, other parameters, such as, for example, air/gas moisture and temperature, may also be evaluated with oxygen concentration. Together with the data from the melting process, a comprehensive quality statement can consequently be made with respect to the resultant component.

FIG. 2 schematically shows the components under inert gas of a process chain processing the powder. These are, described from left to right in the conveying direction of the powder, a delivered container 14 with new powder, the powder silo 2 for the new powder, the sieving station 4 for cleaning the powder conveyed from the powder silo 2, a storage container 15 for the cleaned powder, a process chamber 16 of an installation for the additive manufacturing of components, an unpacking station 17 for unpacking and cleaning a freshly produced component, and the powder silo 2 for excess powder.

All of these components under inert gas of the process chain are connected by way of hoses 8 to the inert gas distributor 7 and have oxygen sensors 10, which are connected by way of control lines 11 to the controller 12 and to the central data processing unit 18. The central data processing unit 18 records the measurement data of the oxygen sensors 10 and evaluates them.

The system 1 makes it possible for customers with increased process requirements to carry out the handling of the powder under controlled environmental conditions all along the process chain. The apparatus 1 may be used, for example, in a modular manner for any desired handling steps in the pre- and post-processing and includes a central controller, feedback control, data acquisition and evaluation.

### Other Embodiments

A number of embodiments of the present disclosure have been described. Nevertheless, it will be understood that various modifications may be made without departing from the spirit and scope of the present disclosure. Accordingly, other embodiments are within the scope of the following claims.

What is claimed is:

1. A system for processing powder suitable for laser melting, the system comprising:
one or more components that come into contact with the powder and to which an inert gas is fed;
a central inert gas distributor, which can be connected to, or is connected to, an inert gas source;
an activatable valve arranged between the central inert gas distributor and the one or more components to control a flow of inert gas from the central inert gas distributor to the one or more components;
an oxygen sensor arranged in or on the one or more components and configured to measure oxygen within the component and to provide oxygen measurement data; and
a controller arranged to receive the oxygen measurement data and configured to activate the activatable valve according to the oxygen measurement data.

2. The system of claim 1, wherein the activatable valve is connected to the central inert gas distributor via one or more gas transfer conduits.

3. The system of claim 1, further comprising a central inert gas processing system connected to the central inert gas distributor.

4. The system of claim 3, further comprising a central sieving station for cleaning the powder.

5. The system of claim 4, wherein one or more of the central inert gas distributor, the controller, and the central inert gas processing system are arranged at the central sieving station.

6. The system of claim 1, further comprising a central data processing unit, which records and evaluates the oxygen measurement data from the oxygen sensor.

7. The system of claim 6, wherein at least some or all of the components each have oxygen sensors and the data processing unit records and evaluates the oxygen measurement data from each of the oxygen sensors.

8. The system of claim 1, wherein at least one of the components is a powder silo for storing powder, a sieving station for cleaning the powder conveyed to it from a powder silo, a process chamber of an installation for the additive manufacturing of parts, or an unpacking station for unpacking and cleaning a freshly produced part.

9. A system for processing powder suitable for laser melting, the system comprising:
a plurality of components that each come into contact with the powder and that each receive an inert gas;
a central inert gas distributor arranged to receive an inert gas from an inert gas source;
a plurality of activatable valves arranged such that each of the plurality of components has an activatable valve connected between the component and the central inert gas distributor to selectively control a flow of inert gas from the central inert gas distributor to one, some, or all of the plurality of components;
a plurality of oxygen sensors arranged such that each of the plurality of components has an oxygen sensor configured to measure oxygen within the component and to provide oxygen measurement data; and
a controller arranged to receive the oxygen measurement data from each of the plurality of oxygen sensors and configured to activate the plurality of activatable valves according to the oxygen measurement data from each of the plurality of oxygen sensors.

10. The system of claim 9, wherein the activatable valves are connected to the central inert gas distributor via gas transfer conduits.

11. The system of claim 9, further comprising a central inert gas processing system connected to the central inert gas distributor.

12. The system of claim 11, further comprising a central sieving station for cleaning the powder.

13. The system of claim 12, wherein one or more of the central inert gas distributor, the controller, and the central inert gas processing system are arranged at the central sieving station.

14. The system of claim 10, further comprising a central data processing unit, which records and evaluates the oxygen measurement data from each of the plurality of oxygen sensors.

15. The system of claim 10, wherein at least one of the components is a powder silo for storing powder, a sieving station for cleaning the powder conveyed to it from a powder silo, a process chamber of an installation for the additive manufacturing of parts, or an unpacking station for unpacking and cleaning a freshly produced part.

16. The system of claim 10, wherein components comprise a powder silo for storing powder, a sieving station for cleaning the powder conveyed to it from the powder silo, a process chamber of an installation for the additive manufacturing of components, and an unpacking station for unpacking and cleaning a freshly produced component.

17. A method of processing powder suitable for laser melting, the method comprising:
moving the powder from a powder silo under an inert gas to one or more components that each process the powder under an inert gas;
providing an inert gas to the powder silo and to each of the one or more components by one or more activatable valves, wherein each of the components and the powder silo has a respective activatable valve;
measuring oxygen data in the powder silo and in at least one of the components and providing oxygen measurement data; and
activating the one or more activatable valves on the basis of the oxygen measurement data.

18. The method of claim 17, wherein the oxygen measurement data is a concentration of oxygen or an oxygen percentage of a gas composition.

19. The method of claim 17, wherein providing an inert gas comprises connecting an inert gas distributor to each of the components by gas transfer conduits.

20. The method of claim 17, wherein at least one of the components is a sieving station for cleaning the powder conveyed to it from a powder silo, a process chamber of an installation for the additive manufacturing of parts, or an unpacking station for unpacking and cleaning a freshly produced part.

21. The method of claim 17, wherein the powder comprises one or more of nickel, titanium, or aluminum.

22. The method of claim 17, wherein the inert gas comprises one or both of argon or nitrogen.
